(19) United States
(12) Patent Application Publication
(10) Pub. No.: US 2022/0391827 A1
(43) Pub. Date: Dec. 8, 2022

(54) METHOD AND APPARATUS FOR CONTAINER STACKING PROCESSING, DEVICE, STORAGE MEDIUM AND PRODUCT

(71) Applicant: BEIJING BAIDU NETCOM SCIENCE TECHNOLOGY CO., LTD., Beijing (CN)

(72) Inventor: Yingmin ZHOU, Beijing (CN)

(73) Assignee: BEIJING BAIDU NETCOM SCIENCE TECHNOLOGY CO., LTD., Beijing (CN)

(21) Appl. No.: 17/819,961

(22) Filed: Aug. 16, 2022

(30) Foreign Application Priority Data
Jan. 29, 2022 (CN) 2022101102172

(51) Int. Cl. G06Q 10/08; G06Q 10/04

(52) U.S. Cl. CPC G06Q 10/087; G06Q 10/04

(57) ABSTRACT

The present disclosure provides a method and an apparatus for container stacking processing, a device, a storage medium and a product, and relates to the field of data processing. The specific implementation is as follows: determining at least one pick-up priority corresponding to a storage yard, where the pick-up priority is a planned pick-up order set for containers in the storage yard; determining, based on at least one pick-up priority, a target priority respectively corresponding to at least one to-be-stacked container in the storage yard; performing at least one stacking simulation processing on the at least one to-be-stacked container to obtain a stacking state generated from each simulation and obtain at least one stacking state; selecting, from the at least one stacking state, a target stacking state that meets a target flipping condition, according to the target priority respectively corresponding to the at least one to-be-stacked container.

### CROSS-REFERENCE TO RELATED APPLICATION

This application claims priority to Chinese Patent Application No. 202210110217.2, filed on Jan. 29, 2022, which is hereby incorporated by reference in its entirety.

### TECHNICAL FIELD

The present disclosure relates to the field of big data in the field of data processing and, in particular, relates to a method and an apparatus for container stacking processing, a device, a storage medium and a product.

### BACKGROUND

With an increase of import and export trade, the number of unloading of port containers becomes more and more. A storage yard may be a designated area for container stacking, and a length, a width and a height of the storage yard may be set according to stacking requirements. When stacking containers to the storage yard, usually, the containers are randomly placed in the storage yard, and each container may include a pick-up order composed of a field, a position, a column, and a layer. When a user is about to fetch a target container in the storage yard according to a bill of lading, the corresponding target container is found from the storage yard. In a practical application, when searching for the target container from the storage yard, it takes several times of flipping in the storage yard to obtain the target container. The larger the number of times of flipping, the longer the acquisition time of the target container, resulting in a low fetching efficiency of the container.

### SUMMARY

The present disclosure provides a method and an apparatus for container stacking processing, a device, a storage medium and a product.

According to a first aspect of the present disclosure, a method for container stacking processing is provided, including:

determining at least one pick-up priority corresponding to a storage yard; where the pick-up priority is a planned pick-up order set for containers in the storage yard;

determining, based on the at least one pick-up priority, a target priority respectively corresponding to at least one to-be-stacked container in the storage yard;

performing at least one stacking simulation processing on the at least one to-be-stacked container to obtain a stacking state generated from each simulation and obtain at least one stacking state; where the stacking state includes a simulative stacking position respectively corresponding to the at least one to-be-stacked container after the stacking simulation processing;

selecting, from the at least one stacking state, a target stacking state that meets a target flipping condition, according to the target priority respectively corresponding to the at least one to-be-stacked container.

According to a second aspect of the present disclosure, an apparatus for container stacking processing is provided, including:

at least one processor; and

a memory communicatively connected with the at least one processor; where,

the memory stores an instruction executable by the at least one processor, the instruction is executed by the at least one processor to enable the at least one processor to:

determine at least one pick-up priority corresponding to a storage yard;

where the pick-up priority is a planned pick-up order set for containers in the storage yard;

determine, based on the at least one pick-up priority, a target priority respectively corresponding to at least one to-be-stacked container in the storage yard;

perform at least one stacking simulation processing on at least one to-be-stacked container to obtain a stacking state generated from each simulation and obtain at least one stacking state; the stacking state includes a simulative stacking position respectively corresponding to the at least one to-be-stacked container after the stacking simulation processing;

select, from the at least one stacking state, a target stacking state that meets a target flipping condition, according to the target priority respectively corresponding to the at least one to-be-stacked container.

According to a third aspect of the present disclosure, a non-transitory computer-readable storage medium having a computer instruction stored thereon is provided, where the computer instruction is used to enable the computer to execute the following steps:

determining at least one pick-up priority corresponding to a storage yard; wherein the pick-up priority is a planned pick-up order set for containers in the storage yard;

determining, based on the at least one pick-up priority, a target priority respectively corresponding to at least one to-be-stacked container in the storage yard;

performing at least one stacking simulation processing on the at least one to-be-stacked container to obtain a stacking state generated from each simulation and obtain at least one stacking state; wherein the stacking state comprises a simulative stacking position respectively corresponding to the at least one to-be-stacked container after the stacking simulation processing;

selecting, from the at least one stacking state, a target stacking state that meets a target flipping condition, according to the target priority respectively corresponding to the at least one to-be-stacked container.

It should be understood that contents described in this section are not intended to identify key or important features of the embodiments of the present disclosure, nor are they intended to limit the scope of the present disclosure. Other features of the present disclosure will be easily understood from the following description.

### BRIEF DESCRIPTION OF THE DRAWINGS

The drawings are used to better understand the present solution, and do not constitute a limitation on the present disclosure. Among them:

FIG. 1 is a schematic diagram of application of a method for container stacking processing according to a first embodiment of the present disclosure;

FIG. 2 is a flowchart of a method for container stacking processing according to a second embodiment of the present disclosure;

FIG. 3 is an exemplary diagram of a manner for acquiring a stacking state provided according to an embodiment of the present disclosure;

FIG. 4 is a flowchart of a method for container stacking processing according to a third embodiment of the present disclosure;

FIG. 5 is a flowchart of a method for container stacking processing according to a fourth embodiment of the present disclosure;

FIG. 6a is a schematic diagram of a stacking state provided according to an embodiment of the present disclosure;

FIG. 6b is a schematic diagram of another stacking state provided according to an embodiment of the present disclosure;

FIG. 6c is a schematic diagram of yet another stacking state provided according to an embodiment of the present disclosure;

FIG. 7 is a flowchart of a method for container stacking processing according to a fifth embodiment of the present disclosure;

FIG. 8 is a flowchart of a method for container stacking processing according to a sixth embodiment of the present disclosure;

FIG. 9 is a schematic structural diagram of an apparatus for container stacking processing according to a seventh embodiment of the present disclosure; and

FIG. 10 is a block diagram of an electronic device for implementing to method for container stacking processing according to an embodiment of the present disclosure.

### DETAILED DESCRIPTION OF THE EMBODIMENTS

Exemplary embodiments of the present disclosure are described below with reference to the accompanying drawings, which include various details of the embodiments of the present disclosure to facilitate understanding, and should be considered as merely exemplary. Therefore, those of ordinary skill in the art should recognize that various changes and modifications can be made to the embodiments described herein without departing from the scope and spirit of the present disclosure. Similarly, for clarity and conciseness, descriptions of well-known functions and structures are omitted in the following description.

The technical solution of the present disclosure may be applied to a container stacking and unloading scenario of a port. By determining a pick-up priority of a container, and performing, in a stacking simulation manner, a pick-up simulation on a stacking state of the container in accordance with the pick-up priority of the container to obtain a final target stacking state, the container can have a maximum stacking effect and the stacking efficiency of the container can be improved.

In a related art, when containers are being stacked, they are usually stacked randomly, or they are unloaded from a cargo ship and then placed in a storage yard in sequence according to an unloading order. When a user is about to fetch a container, the corresponding target container is found from the storage yard in accordance with a bill of loading. In a practical application, the containers in the storage yard may be positioned in accordance with a field, a position, a column, and a layer. In practice, a pick-up order may be accurately defined by concepts such as the field, the position, the column and the layer. In a pick-up, the storage yard may be positioned according to the bill of loading, and the target container may be specifically positioned in terms its position, column and layer in the storage yard. And the target container is fetched from the storage yard according to the positioning of the target container. When fetching the container from the storage yard, it may need to flip the containers in the storage yard for a fetch. In an actual fetch, the number of times of flipping is large, resulting in a low efficiency for container fetching.

In order to solve the above technical problem, in the embodiment of the present disclosure, a stacking simulation is performed for a container in the storage yard, and an actual fetching priority is determined. For the containers in the storage yard, a stacking state with a least number of times of flipping is acquired through the actual fetching priority of the container, and container stacking is performed in accordance with this stacking state, so that the number of times of flipping is minimized when the container is fetched, and the fetching efficiency of the container is improved.

The present disclosure provides a method and an apparatus for container stacking processing, a device, a storage medium and a product, which are applied to the field of big data in the field of data processing to improve unloading efficiency of containers in a port.

The technology according to the present disclosure solves the problem that the material fetching efficiency is low during a pick-up when containers are randomly stacked to a storage yard. According to the technical solution of the present disclosure, at least one pick-up priority corresponding to a storage yard may be determined, where the pick-up priority may be a planned pick-up order set for containers in the storage yard. The planned pick-up order may be an actual order for container fetching. A target priority respectively corresponding to at least one to-be-stacked container in the storage yard may be determined based on the at least one pick-up priority. The determination of the target priority of the to-be-stacked container may render an accurate confirmation on a pick-up order of the to-be-stacked container. At least one stacking simulation processing is performed on the at least one to-be-stacked container to obtain a stacking state generated from each simulation and obtain at least one stacking state. The stacking state may include a simulative stacking position respectively corresponding to the at least one to-be-stacked container after the stacking simulation processing. A target stacking state that meets a target flipping condition in the at least one stacking state may be confirmed through determining the target priority respectively corresponding to the at least one to-be-stacked container, that is, an actual corresponding pick-up order of each stacking container, thereby achieving acquisition of the target stacking state. By acquiring the target stacking state, the simulative stacking position of the at least one to-be-stacked container may be determined, thereby reducing the number of times of flipping in a pick-up process and improving the stacking efficiency.

The technical solutions of the present disclosure will be described in detail below with reference to the accompanying drawings.

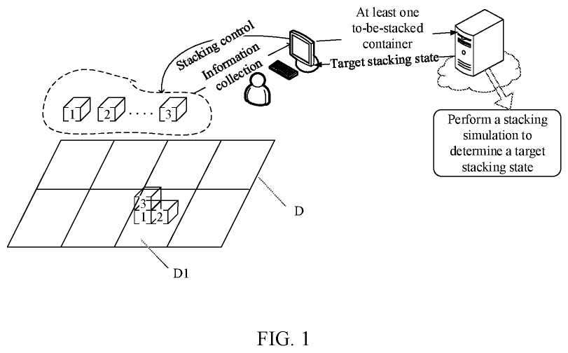

For ease of understanding, FIG. 1 shows an exemplary diagram of application of a method for container stacking processing according to a first embodiment of the present disclosure. In a practical application, a port may include at least one storage yard D. A target stacking state of at least one to-be-stacked container corresponding to any storage yard may be confirmed in accordance with the method for container stacking processing provided in the embodiment of the present disclosure, so as to realize an accurate stacking of the at least one to-be-stacked container in the storage yard. A user that manages the storage yard may transmit information of the storage yard, such as a storage yard identifier, a size and other information, to a backend server 2 through a user equipment 1, for example, the backend server 2 may be a cloud server. Assuming that the storage yard selected by the user that manages storage yards is D1, at least one to-be-stacked container J in D1 may be provided to the backend server 2. The backend server 2 may determine the storage yard D1 and at least one to-be-stacked container corresponding to the storage yard D1, for example, respectively numbered as containers 1, 2, and 3. After that, the background server 2 may determine a target stacking state of the at least one to-be-stacked container J in the storage yard D1 so that at least one to-be-stacked container is stacked in the storage yard D1 in accordance with the target stacking state, as shown in FIG. 1, in the stacking states the container 1 is located on the left of the container 2, the container 3 is located above the container 1, respectively. The accurate stacking of at least one to-be-stacked container can be realized, so that the target stacking state of the at least one to-be-stacked container corresponds to an actual pick-up priority, thereby improving the pick-up efficiency of the container.

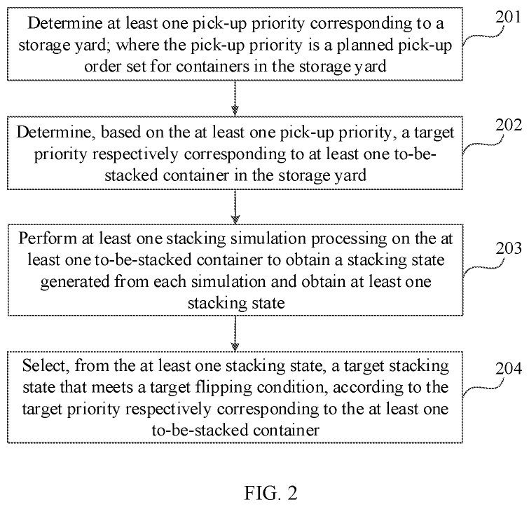

FIG. 2 shows a flowchart of a method for container stacking processing according to a second embodiment of the present disclosure, the method may include the following steps.

201, determine at least one pick-up priority corresponding to a storage yard; where the pick-up priority is a planned pick-up order set for containers in the storage yard.

In an embodiment, the planned pick-up order may be an order set for containers. The storage yard may include any of a plurality of storage yards. The storage yard may be distinguished by its storage yard identifier. Different storage yards have different stacking identifiers. A storage yard may have corresponding storage yard information. The storage yard information may include: a storage yard position, a storage yard height and other information.

The pick-up order may refer to a pick-up order corresponding to a container in the storage yard.

In a possible design, the at least one pick-up priority of the storage yard may be set by the user that manages the storage yard, for example, the pick-up orders of containers with the same container information may be set under a pick-up priority. The at least one pick-up priority may also be randomly assigned and optimized by an actual pick-up order to obtain the at least one pick-up priority with higher accuracy.

202, determine, based on the at least one pick-up priority, a target priority respectively corresponding to at least one to-be-stacked container in the storage yard.

For any container to be stacked in the storage yard, the target priority may be determined from the at least one pick-up priority. The target priority may be the planned pick-up order for the container to be stacked.

The target priority of the container to be stacked may be selected and obtained from the at least one pick-up priority.

203, perform at least one stacking simulation processing on the at least one to-be-stacked container to obtain a stacking state generated from each simulation and obtain at least one stacking state.

The stacking state includes a simulative stacking position respectively corresponding to the at least one to-be-stacked container after the stacking simulation processing. When the stacking simulation processing is performed on the at least one to-be-stacked container, the stacking position of the at least one to-be-stacked container may be confirmed. After the stacking position is determined, when the container is unloaded, the unloading may be performed in accordance with the determined stacking position. The stacking position of the to-be-stacked container may be composed of a three-dimensional array corresponding to a position, a column and a layer of the stacking container in the storage yard.

204, select, from the at least one stacking state, a target stacking state that meets a target flipping condition, according to the target priority respectively corresponding to the at least one to-be-stacked container.

In an embodiment, the target flipping condition may include a minimum number of times of flipping. The number of times of flipping may refer to the number of times for flipping the un-fetched containers when the container is fetched from the storage yard.

The at least one to-be-stacked container that is stacked in accordance with the stacking state may be picked up according to the target priority respectively corresponding to the at least one to-be-stacked container, and the number of times of flipping may be obtained when fetching each container. The selecting, from the at least one stacking state, the target stacking state that meets the target flipping condition, according to the target priority respectively corresponding to the at least one to-be-stacked container may include performing an unloading simulation on the stacking state according to the target priority respectively corresponding to the at least one to-be-stacked container to obtain the number of times of flipping corresponding to the stacking state, and obtain the number of times of flipping respectively corresponding to at least one stacking state; the stacking state with the smallest number of times of flipping is determined as the target stacking state that meets the target flipping condition.

In the embodiment of the present disclosure, at least one pick-up priority corresponding to a storage yard may be determined, the pick-up priority may be a planned pick-up order set for containers in the storage yard. The planned pick-up order may be an actual order for container fetching. A target priority respectively corresponding to at least one to-be-stacked container in the storage yard may be determined based on the at least one pick-up priority. The determination of the target priority of the to-be-stacked container may render an accurate confirmation on a pick-up order of the to-be-stacked container. At least one stacking simulation processing is performed on the at least one to-be-stacked container to obtain a stacking state generated from each simulation and obtain at least one stacking state. The stacking state may include a simulative stacking position respectively corresponding to the at least one to-be-stacked container after the stacking simulation processing. A target stacking state that meets a target flipping condition in the at least one stacking state may be confirmed through the target priority respectively corresponding to the at least one to-be-stacked container, that is, an actual corresponding pick-up order of each stacking container, thereby achieving acquisition of the target stacking state. By acquiring the target stacking state, the simulative stacking position of the at least one to-be-stacked container may be determined, thereby reducing the number of times of flipping in a pick-up process and improving the stacking efficiency.

As an example, in a practical application, the stacking simulation processing may be completed by means of randomly determining the position of the container to be stacked, and a randomly generated stacking state may be obtained. In order to improve the efficiency of acquiring the stacking state, the at least one stacking simulation processing is performed on the at least one to-be-stacked container to obtain the stacking state generated from each simulation, which may include: performing, by using the target priority respectively corresponding to the at least one to-be-stacked container, the at least one stacking simulation processing on the at least one to-be-stacked container to obtain the stacking state generated from each simulation. The stacking simulation is performed by using the target priority respectively corresponding to the at least one to-be-stacked container, the containers with the same target priority may be stacked together, so that the stacked containers can be picked centrally when picking up, thereby improving the pick-up efficiency.

The performing the at least one stacking simulation processing on the at least one to-be-stacked container to obtain the stacking state generated from each simulation may specifically include: classifying the at least one to-be-stacked container in accordance with their respective target priorities to obtain target containers respectively corresponding to at least one target priority;

performing a sub-stacking simulation on target containers belonging to a same target priority to obtain at least one sub-state of the target priority, and determine at least one sub-state respectively corresponding to the at least one target priority;

for any stacking simulation processing, determining a target sub-state from at least one sub-state of any target priority, selecting a corresponding target sub-state for the at least one target priority sequentially;

performing a state splicing on the target sub-state of the at least one target priority to obtain the stacking state generated from the stacking simulation processing.

In the embodiment of the present disclosure, the stacking simulation is performed by using the target priority respectively corresponding to the at least one to-be-stacked container, the containers with the same target priority may be stacked together, so that the stacked containers can be picked centrally when picking up, thereby improving the pick-up efficiency.

The performing the state splicing on the target sub-state of the at least one target priority to obtain the stacking state generated from the stacking simulation processing may include: performing the state splicing on the target sub-state of the at least one target priority to obtain the stacking state generated from the stacking simulation processing in accordance with a level of a priority order respectively corresponding to the at least one target priority. That is, those with a higher priority order are stacked first, and those with a lower priority order are stacked later.

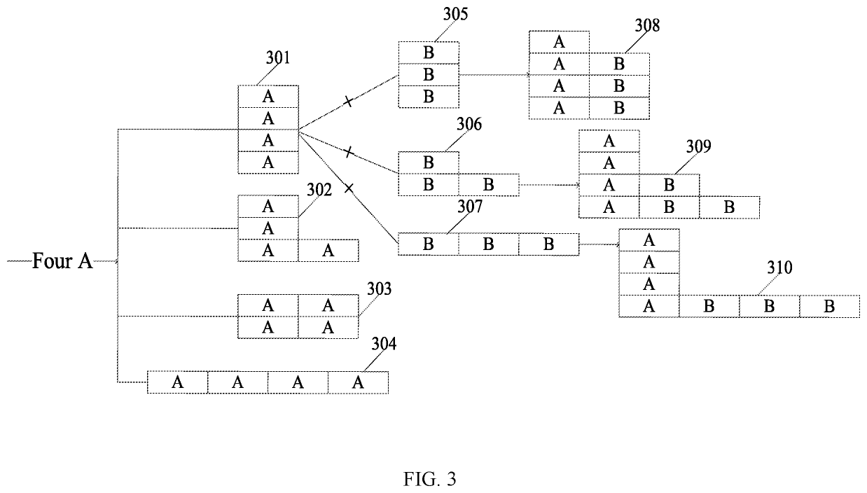

For ease of understanding, it is assumed that there are 4 containers to be stacked in the first priority, all of them are marked as A. During the stacking simulation, the above four containers may be stacked in different stacking manners, and four sub-stacking states may be obtained. As shown in FIG. 3, a stacking sub-state 301 in the longitudinal direction, a stacking sub-state 302 with three in the longitudinal direction and one in the lateral direction, a stacking sub-state 303 with two in the longitudinal direction and two in the lateral direction, and a stacking sub-state 304 in the lateral direction.

There are 3 containers to be stacked in the second priority, all of them are marked as B. During the stacking simulation, a stacking sub-state 305 with three in the longitudinal direction, a stacking sub-state 306 with two in the longitudinal direction and one in the lateral direction, and a stacking sub-state 307 with three in the lateral direction may be obtained. When simulating a stacking state, a sub-state of the first priority and a sub-state of the second priority may be selected. FIG. 3 shows the stacking splicing of the stacking sub-state 301 of A and three stacking sub-states of B, the stacking splicing of the other stacking sub-states of A and the three stacking sub-states of B is not shown. In FIG. 3, the sub-state 301 and the sub-state 305 are stacked to produce a stacking state 308, the sub-state 301 and the sub-state 306 are stacked to produce a stacking state 309, and the sub-state 301 and the sub-state 307 are stacked to produce a stacking state 310, and so on. For different stacking states, the stacking positions of the containers may be different. When the target priority contains more than one, stackable sub-states may be listed and illustrated according to the containers of the target priorities shown in FIG. 3, and the stacking simulation of the sub-states may be performed for each target priority, and then the splicings on the sub-states are selected for the multiple target priorities sequentially to obtain the stacking state.

As an embodiment, determining the at least one pick-up priority corresponding to the storage yard includes:

acquiring plural pieces of historical pick-up information of the storage yard, where the historical pick-up information includes a historical pick-up order of a container that has been picked up;

determining, according to historical pick-up orders respectively corresponding to the plural pieces of historical pick-up information, the at least one pick-up priority.

The historical pick-up information may include: the cargo type, the pick-up company, the shipping company to which the vessel belongs, whether the cargo is expedited, the average delay of pick-up, the on-time rate of the bill of loading and other transportation information, as well as the actual historical container picking-up order.

The at least one pick-up priority may be determined from the historical pick-up orders respectively corresponding to the plural pieces of historical pick-up information.

In the embodiment of the present disclosure, the at least one pick-up priority may be extracted through the plural pieces of historical pick-up information of the storage yard, and thus the integration of the pick-up priority with the historical pick-up orders of the plural pieces of historical pick-up information is realized, so that the at least one pick-up priority may be divided more accurately.

In a possible design, the determining, according to the historical pick-up orders respectively corresponding to the plural pieces of historical pick-up information, the at least one pick-up priority includes:

performing a clustering processing on the plural pieces of historical pick-up information to obtain at least one information category; where the information category includes at least one piece of historical pick-up information that meets a pick-up similarity condition;

determining, according to a historical pick-up order respectively corresponding to the at least one piece of historical pick-up information in the information category, a pick-up priority corresponding to the information category to obtain the pick-up priority respectively corresponding to the at least one information category.

The performing the clustering processing on the plural pieces of historical pick-up information to obtain the at least one information category may include: performing the clustering processing on transportation information respectively corresponding to the plural pieces of historical pick-up information, and determining at least one piece of historical pick-up information whose transportation information meets an information similarity condition to be in the same information category. The transportation information meeting the information similarity condition may refer to the transportation information being the same or a similarity of the transportation information being higher than a similarity threshold.

In the embodiment of the present disclosure, the at least one information category may be obtained by performing the clustering processing on the plural pieces of historical pick-up information. Each information category includes at least one piece of historical pick-up information that meets a pick-up similarity condition. Clustering the pick-up information in accordance with a pick-up similarity is realized, so that the historical pick-up information with the similarity is divided into the same information category. Further, by using the historical pick-up order respectively corresponding to the at least one piece of historical pick-up information in the information category, the pick-up priority corresponding to the information category is determined so as to obtain the pick-up priority respectively corresponding to the at least one information category. The pick-up priority being determined in accordance with the information category may make the priority determining manner in terms of the information category more accurate, thereby improving the accuracy of the information category determination, and realizing the accurate determination of the pick-up priority corresponding to the same information category.

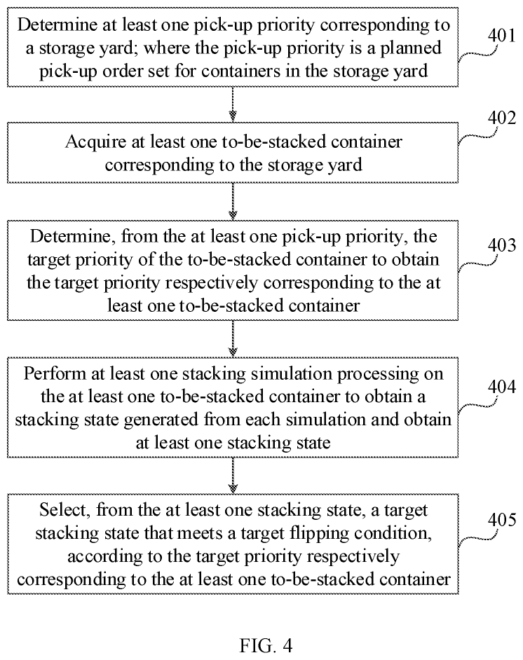

FIG. 4 shows a flowchart of a method for container stacking processing according to a third embodiment of the present disclosure. The method may include the following steps.

401, determine at least one pick-up priority corresponding to a storage yard; where the pick-up priority is a planned pick-up order set for containers in the storage yard.

It should be noted that in the embodiment of the present disclosure, some steps are the same as those in the foregoing embodiments, and are not repeated here for the sake of brevity of description.

402, acquire at least one to-be-stacked container corresponding to the storage yard.

The acquiring the at least one to-be-stacked container corresponding to the storage yard may include: receiving the at least one to-be-stacked container sent by a user equipment. The at least one to-be-stacked container is distinguished by a container identifier, at the same time the at least one to-be-stacked container is respectively associated with pick-up information. The pick-up information may include transportation information.

403, determine, from the at least one pick-up priority, the target priority of the to-be-stacked container to obtain the target priority respectively corresponding to the at least one to-be-stacked container.

The target priority of the to-be-stacked container may be the pick-up order of the to-be-stacked container. That is, the target priority may be the pick-up order of container prediction for the to-be-stacked container.

404, perform at least one stacking simulation processing on the at least one to-be-stacked container to obtain a stacking state generated from each simulation and obtain at least one stacking state; where the stacking state includes a simulative stacking position respectively corresponding to the at least one to-be-stacked container after the stacking simulation processing.

405, select, from the at least one stacking state, a target stacking state that meets a target flipping condition, according to the target priority respectively corresponding to the at least one to-be-stacked container.

In the embodiment of the present disclosure, after the at least one pick-up priority is determined, the at least one to-be-stacked container corresponding to the storage yard may be acquired. The target priority of the to-be-stacked container is determined from the at least one pick-up priority to obtain the target priority respectively corresponding to the at least one to-be-stacked container. The target priority of each to-be-stacked container is determined from the at least one pick-up priority, so that the priority of the to-be-stacked container may be accurately determined, and the accuracy of the target priority determination may be improved.

As an embodiment, the determining, from the at least one pick-up priority, the target priority of the to-be-stacked container includes:

extracting, according to pick-up information of the to-be-stacked container, a pick-up feature of the to-be-stacked container;

determining a pick-up probability of the pick-up feature at the pick-up priority to obtain the pick-up probability respectively corresponding to the pick-up feature at the at least one pick-up priority;

determining, from the pick-up probability respectively corresponding to the at least one pick-up priority, a pick-up priority corresponding to a maximum pick-up probability as the target priority.

As a possible implementation, the determining the pick-up probability of the pick-up feature at the pick-up priority includes: calculating the pick-up probability of the pick-up feature at the pick-up priority by using a Naive Bayes formula. As another possible implementation, the determining the pick-up probability of the pick-up feature at the pick-up priority may further include: determining a historical pick-up feature corresponding to the historical pick-up information in the pick-up priority, and calculating a feature similarity between the pick-up feature and the historical pick-up feature to obtain the pick-up probability corresponding to the pick-up feature at the priority. The historical pick-up feature may be any piece of historical pick-up information in the pick-up priority or an average feature of the pick-up features respectively corresponding to the at least one piece of historical pick-up information in the pick-up priority.

In the embodiment of the present disclosure, the pick-up feature of the to-be-stacked container may be extracted according to the pick-up information of the to-be-stacked container. The pick-up feature may characterize an index related to the pick-up of the to-be-stacked container. By determining the pick-up probability corresponding to the pick-up feature at the pick-up priority, the pick-up probability respectively corresponding to the pick-up feature at the at least one pick-up priority may be obtained, and by obtaining the pick-up probability respectively corresponding to the at least one pick-up priority of the to-be-stacked container, the pick-up priority corresponding to the maximum pick-up probability is determined as the target priority. The pick-up priority of the to-be-stacked container may be accurately determined through the pick-up probability, thereby improving the accuracy of the target priority determination of each to-be-stacked container.

In some embodiments, the determining the pick-up probability of the pick-up feature at the pick-up priority may include:

determining a priority probability respectively corresponding to the at least one pick-up priority;

determining a feature probability corresponding to the pick-up feature;

determining a priori probability corresponding to the pick-up priority at the pick-up feature;

inputting he priority probability, the feature probability and the priori probability into a Naive Bayes formula, calculating to obtain a corresponding posterior probability to determine the posterior probability as the pick-up probability.

In an embodiment, the feature probability corresponding to the pick-up feature may be a probability that a number of containers with the pick-up feature accounts for a total number. The pick-up feature may be obtained by performing a feature extracting on the pick-up information of the to-be-stacked container, specifically records on different pick-up attributes of the pick-up information.

The inputting the priority probability, the feature probability and the priori probability into the Naive Bayes formula, and the calculating to obtain the corresponding posterior probability include: calculating a product of the posterior probability and the priority probability to obtain first data, and calculating a quotient of the first data and the feature probability to obtain the posterior probability. Assuming that the priori probability is expressed as: P (pick-up feature|pick-up priority), the priority probability is expressed as: P (pick-up priority), the feature probability is expressed as: P (feature probability), then the posterior probability may be expressed as:

P(pick-up priority|pick-up feature)=P(pick-up feature|pick-up priority)*P(pick-up priority)/P(feature probability).

The calculated posterior probability: P (pick-up priority pick-up feature) is the pick-up probability.

In the embodiment of the present disclosure, the probability determination of the possibility of each pick-up priority is performed by calculating the priority probability respectively corresponding to the at least one pick-up priority. The feature probability corresponding to the pick-up feature may also be determined, so as to realize the determination of the probability of the corresponding feature. And the priori probability corresponding to the pick-up priority at the pick-up feature is determined, that is, a probability corresponding to a certain pick-up priority at a certain pick-up feature is determined, the priority probability, the feature probability and the priori probability are input into the Naive Bayes formula, the posterior probability corresponding to the pick-up feature at a certain pick-up priority is obtained through calculation, where the posterior probability is the pick-up probability, so that acquisition of a probability distribution result of the pick-up feature at different pick-up priorities is achieved. The pick-up feature may be obtained accurately through the probability distribution calculation, and at the same time, the Naive Bayes formula has a low computational complexity, so that the pick-up probability of the pick-up feature at the pick-up priority may be determined quickly and accurately.

In a possible design, the determining the feature probability corresponding to the pick-up feature includes:

determining the plural pieces of historical pick-up information;

extracting a historical pick-up feature respectively corresponding to the historical pick-up information to obtain a plurality of historical pick-up features;

determining, from the plurality of historical pick-up features, a feature number of historical pick-up features that are the same as the pick-up feature;

calculating a ratio of the feature number to a total number of the plural pieces of historical pick-up information to obtain the feature probability corresponding to the pick-up feature.

The feature probability may be a probability at which any piece of historical pick-up information belongs to a certain pick-up feature.

In the embodiment of the present disclosure, the plural pieces of historical pick-up information may be determined, and historical pick-up probalbilities respectively corresponding to the plural piece of historical pick-up information may be extracted to obtain the plurality of historical pick-up features. The number of historical pick-up features that are the same as the pick-up feature is determined from the plurality of historical pick-up features, so that the determination of the number of pieces of historical pick-up information with the pick-up feature can be realized, and the feature probability corresponding to the pick-up feature is obtained by using the ratio of the feature number to the total number of the plural pieces of historical information, thereby accomplishing the calculation of the feature probability fast and accurately.

In another possible design, the determining the priority probability respectively corresponding to the at least one pick-up priority may include: performing a clustering processing on the plural pieces of historical pick-up information to obtain at least one information category, where the information category includes at least one piece of historical pick-up information that meets a pick-up similarity condition;

calculating, according to an information number of at least one piece of historical pick-up information of the information category, a ratio of the information number to the total number of the plural pieces of historical pick-up information to obtain the priority probability corresponding to the information category; each information category corresponds to a pick-up priority;

obtaining the priority probability of the pick-up priority respectively corresponding to the at least one information category.

In the embodiment of the present disclosure, an information classification is performed on the historical pick-up information by using the at least one piece of historical pick-up information in the information category, the information category actually corresponds to the pick-up priority. The information number of the at least one piece of historical pick-up information in each information category is determined, and the ratio of the information number to the total number of the plural pieces of historical pick-up information is calculated to obtain the priority probability of the information category, so that an accurate acquisition of the feature probability of the at least one pick-up priority is realized. With a large amount of pieces of historical pick-up information as a calculation basis for the priority probability, the accurate priority probability respectively corresponding to the pick-up priority can be obtained.

As a possible implementation, the extracting, according to the pick-up information of the to-be-stacked container, the pick-up feature of the to-be-stacked container may include:

acquiring at least one target factor that affects priority confirmation;

determining, according to the pick-up information of the to-be-stacked container, feature data respectively corresponding to the to-be-stacked container at the at least one target factor;

determining the pick-up feature obtained from a feature splicing on the feature data respectively corresponding to the at least one target factor.

The pick-up information of the to-be-stacked container may include: the cargo type, the pick-up company, the shipping company to which the vessel belongs, whether the cargo is expedited, the average delay of pick-up, the on-time rate of the bill of loading and other transportation information. Before determining the target priority, the pick-up order in the pick-up information of the to-be-stacked container is empty. When the target priority of the to-be-stacked container is obtained, the target priority may be used as the pick-up order in the pick-up information.

The at least one target factor may be transportation information, in the pick-up information, that affects the priority confirmation; and the at least one target factor may include at least one of: the cargo type, the pick-up company, the shipping company to which the vessel belongs, whether the cargo is expedited, the average delay of pick-up, the on-time rate of the bill of loading.

The pick-up feature of the to-be-stacked container is extracted according to the transportation information in the pickup information of the to-be-stacked container. The specific steps of obtaining the pick-up feature may include: converting the cargo type, the pick-up company, the shipping company to which the vessel belongs, whether the cargo is expedited, the average delay of pick-up, the on-time rate of the bill of loading in the pick-up information respectively into corresponding feature data, and splicing the feature data respectively corresponding to the cargo type, the pick-up company, the shipping company to which the vessel belongs, whether the cargo is expedited, the average delay of pick-up and the on-time rate of the bill of loading, to obtain the pick-up feature.

In the embodiment of the present disclosure, the at least one target factor may be acquired, and the target factor may affect priority confirmation of the to-be-stacked container. For the pick-up information of the to-be-stacked container, the feature data respectively corresponding to the to-be-stacked container at least one target factor is determined to obtain the feature data respectively corresponding to the at least one target factor, and the feature data respectively corresponding to the at least one target factor may constitute the pick-up feature of the to-be-stacked container. Through the at least one target factor, the data affecting the priority confirmation may be determined from the pick-up information of the to-be-stacked container, so as to realize an accurate extraction of the pick-up feature.

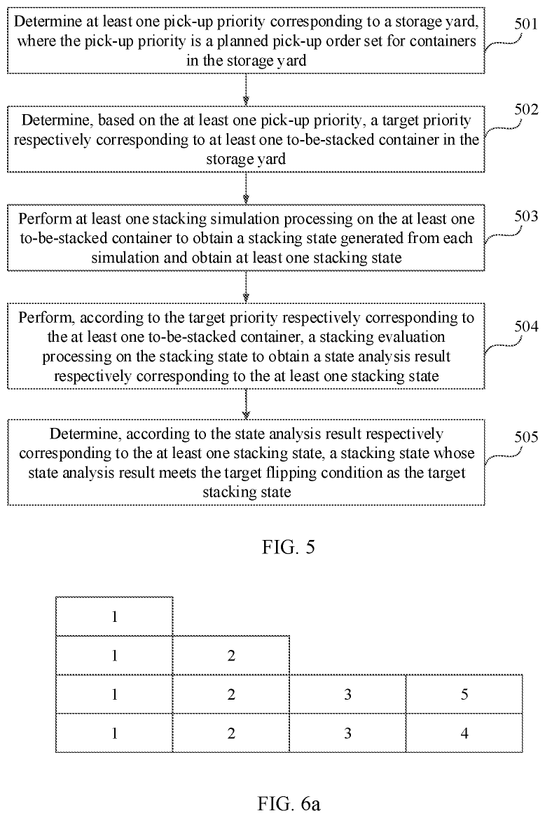

FIG. 5 shows a flowchart of a method for container stacking processing according to a fourth embodiment of the present disclosure. The method may include the following steps.

501, determine at least one pick-up priority corresponding to a storage yard, where the pick-up priority is a planned pick-up order set for containers in the storage yard.

It should be noted that in the embodiment of the present disclosure, some steps are the same as those in the foregoing embodiments, and are not repeated here for the sake of brevity of description.

502, determine, based on the at least one pick-up priority, a target priority respectively corresponding to at least one to-be-stacked container in the storage yard.

503, perform at least one stacking simulation processing on the at least one to-be-stacked container to obtain a stacking state generated from each simulation and obtain at least one stacking state; where the stacking state includes a simulative stacking position respectively corresponding to the at least one to-be-stacked container after the stacking simulation processing.

504, perform, according to the target priority respectively corresponding to the at least one to-be-stacked container, a stacking evaluation processing on the stacking state to obtain a state analysis result respectively corresponding to the at least one stacking state.

The target priority respectively corresponding to the at least one to-be-stacked container is a pick-up order respectively predicted for the at least one to-be-stacked container. The state analysis result of the stacking state may be obtained by performing the stacking evaluation processing on the stacking state according to the target priority respectively corresponding to the at least one to-be-stacked container. When the stacking evaluation processing of the at least one stacking state is ended, the state analysis result respectively corresponding to the at least one stacking state may be obtained.

505, determine, according to the state analysis result respectively corresponding to the at least one stacking state, a stacking state whose state analysis result meets the target flipping condition as the target stacking state.

In the embodiment of the present disclosure, after the at least one stacking state is determined, the stacking evaluation processing may be performed on each stacking state according to the target priority respectively corresponding to the at least one to-be-stacked container to obtain the state analysis result respectively corresponding to the at least one stacking state. The stacking evaluation of the at least one stacking state is realized. Thereby the stacking state whose state analysis result meets the target flipping condition is determined as the target stacking state according to the state analysis result respectively corresponding to the at least one stacking state. A state selection is performed on the state analysis result respectively corresponding to the at least one stacking state through the target flipping condition, so as to realize an accurate acquisition of the state.

As an embodiment, the determining, according to the state analysis result respectively corresponding to the at least one stacking state, the stacking state whose state analysis result meets the target flipping condition as the target stacking state includes:

traversing the at least one stacking state to determine a current stacking state and a candidate stacking state that is determined from a previous result comparison processing;

performing a result comparison processing between a state analysis result of the current stacking state and a state analysis result of the candidate stacking state to determine a new candidate stacking state whose state analysis result meets the target flipping condition, returning to the step of traversing the at least one stacking state to determine the current stacking state and the previously determined candidate stacking state, and proceeding with the execution until the traversing of the at least one stacking state ends;

obtaining a new candidate stacking state obtained from a last traversal as the target stacking state.

In the embodiment of the present disclosure, by traversing the at least one stacking state, the current stacking state and the candidate stacking state obtained from the previous result comparison processing may be determined. In each traversal, by performing the result comparision processing between the state analysis result of the current stacking state and the state analysis result of the candidate stacking state, the new candidate stacking state whose state analysis result meets the target flipping condition may be determined, so as to realize an update of the candidate stacking state. By continuously traversing the at least one stacking state, the target flipping condition may be determined for each stacking state, until the traversing of the at least one stacking state ends. By obtaining the new candidate stacking state obtained from the last traversal as the target stacking state, and by comparing the at least one stacking state, the target stacking state may be accurately obtained, thereby improving the acquisition efficiency and accuracy of the target stacking state.

In a possible design, the performing, according to the target priority respectively corresponding to the at least one to-be-stacked container, the stacking evaluation processing on the stacking state to obtain the state analysis result respectively corresponding to the at least one stacking state includes:

determining at least one state analysis factor;

determining the simulative stacking position respectively corresponding to the at least one to-be-stacked container in the stacking state;

extracting, according to the simulative stacking position and the target priority respectively corresponding to the at least one to-be-stacked container, state data corresponding to the state analysis factor to obtain the state data respectively corresponding to the at least one state analysis factor;

determining the state data respectively corresponding to the at least one state analysis factor as the state analysis result of the stacking state to obtain the state analysis result respectively corresponding to the at least one stacking state.

The state data of any state analysis factor may be determined according to the simulative stacking position and the target priority respectively corresponding to the at least one to-be-stacked container. Specifically, a stacking simulation can be performed on the at least one to-be-stacked container according to the simulative stacking position respectively corresponding to the at least one to-be-stacked container to obtain the at least one to-be-stacked container after being stacked. According to the target priority respectively corresponding to the at least one to-be-stacked container, a pick-up simulation is actually determined to be performed on the at least one to-be-stacked container after being stacked, to obtain the state data corresponding to the state analysis factor.

In the embodiment of the present disclosure, by determining the at least one state analysis factor, the simulative stacking position respectively corresponding to the at least one to-be-stacked container in the stacking state may be determined, the state data corresponding to the state analysis factor may be extracted according to the simulative stacking position and the target priority respectively corresponding to the at least one to-be-stacked container to obtain the state data respectively corresponding to the at least one state analysis factor. The simulative stacking position and the target priority are respectively a simulative order and an actual order of the to-be-stacked container, which may be used to accurately extract the state data of the state analysis factor and improve the accuracy of the state data acquisition.

In some embodiments, the performing the result comparison processing between the state analysis result of the current stacking state and the state analysis result of the candidate stacking state to determine the new candidate stacking state whose state analysis result meets the target flipping condition includes:

determining first state data respectively corresponding to the at least one state analysis factor in the state analysis result of the current stacking state and second state data respectively corresponding to the at least one state analysis factor in the state analysis result of the candidate stacking state;

determining, starting from a first state analysis factor, a current state analysis factor in accordance with an analysis order respectively corresponding to the at least one state analysis factor;

for the current state analysis factor, if it is determined that the first state data of the current state analysis factor in the current stacking state is smaller than the second state data corresponding to the candidate stacking state, then determining the current stacking state as the new candidate stacking state;

if it is determined that the first state data of the current state analysis factor in the current stacking state is greater than the second state data corresponding to the candidate stacking state, then determining the candidate stacking state as the new candidate stacking state;

if it is determined that the first state data of the current state analysis factor in the current stacking state is equal to the second state data corresponding to the candidate stacking state, returning to the step of determining, starting from the first state analysis factor, the current state analysis factor in accordance with the analysis order respectively corresponding to the at least one state analysis factor, and proceeding with the execution until comparison of a last state analysis factor ends;

if it is determined that the first state data of the last state analysis factor in the current stacking state is equal to the second state data corresponding to the candidate stacking state, then determining both the current stacking state and the candidate stacking state as the new candidate stacking state.

In the embodiment of the present disclosure, in a case of performing the result comparison processing, first state data respectively corresponding to the at least one state analysis factor in the state analysis result of the current stacking state and second state data respectively corresponding to the at least one state analysis factor in the state analysis result of the candidate stacking state may be determined. Starting from the first state analysis factor, the current state analysis factor is determined initially in accordance with an analysis order respectively corresponding to the at least one state analysis factor, so as to realize a determination of the state analysis factor to be analyzed. By comparing the first state data of the current state analysis factor with the second state data in terms of their size, a data comparison of the current state analysis factor is realized to obtain an accurate candidate stacking state and realize an accurate acquisition of the candidate stacking state.

In a possible design, the at least one state analysis factor includes an inversion pair, an inversion pair difference and a flipping parameter; the method further includes:

determining, in accordance with an order from high to low, the analysis order respectively corresponding to the inversion pair, the inversion pair difference, and the flipping parameter.

The analysis order is determined as follows: the inversion pair is higher than the inversion pair difference, the inversion pair difference is higher than the flipping parameter.

The inversion pair may refer to the target priority of any to-be-stacked container being greater than the target priority of another to-be-stacked container after its position in a priority sequence. For example, there are two inversion pairs in 312, which are (3,1) and (3,2). If the priority of 1 is less than 2, it means that the pick-up priority of 1 is before 2, and (1,2) is not an inversion pair.

In the embodiment of the present disclosure, it is determined that the at least one state analysis factor includes the inversion pair, the inversion pair difference, and the flipping parameter. The analysis order respectively corresponding to the inversion pair, the inversion pair difference and the flipping parameter may be determined in accordance with an order from high to low. An accurate definition of the at least one state analysis factor is realized through the inversion pair, the inversion pair difference, and the flipping parameter, so as to realize an accurate state analysis for the stacking state through the state analysis result.

As a possible implementation, the extracting, according to the simulative stacking position and the target priority respectively corresponding to the at least one to-be-stacked container, the state data corresponding to the state analysis factor to obtain the state data respectively corresponding to the at least one state analysis factor includes:

determining, according to the target priority respectively corresponding to the at least one to-be-stacked container, a target inversion pair of the stacking state;

determining a number of inversion pairs corresponding to the stacking state in the target inversion pair;

calculating a difference value between two target priorities in the target inversion pair to obtain an inversion pair difference value of the target inversion pair;

obtaining a number of times of flipping corresponding to the stacking state at the flipping parameter, according to the simulative stacking position respectively corresponding to at least one to-be-stacked container in the stacking state and a number of times of flipping needs to be performed when performing a simulation pick-up in accordance with the target priority respectively corresponding to the at least one to-be-stacked container;

determining the number of inversion pairs as the state data of the inversion pair, the inversion pair difference value as the state data of the inversion pair difference, and the number of times of flipping as the state data of the flipping parameter.

The determining, according to the target priority respectively corresponding to the at least one to-be-stacked container, the target inversion pair of the stacking state includes: determining at least one first inversion pair according to the priority sequence corresponding to the target priority respectively corresponding to the at least one to-be-stacked container; determining, according to the target priority respectively corresponding to the at least one to-be-stacked container in the stacking state, at least one second inversion pair obtained when stacking in the stacking state; determining an intersection of the at least one first inversion pair and the at least one second inversion pair to obtain a third inversion pair; acquiring a target inversion pair in the at least one second inversion pair except the third inversion pair. When the third inversion pair may be an empty inversion pair, any first inversion pair is different from the at least one second inversion pair, and any second inversion pair is also different from the at least one first inversion pair.

The determining, according to the target priority respectively corresponding to the at least one to-be-stacked container in the stacking state, the at least one second inversion pair obtained when stacking in the stacking state may include: for any column of containers in the stacking state, comparing the target priority of any first container in the column of containers with the target priority of each underlaid second container in a same column; if the target priority of the second container below is lower than the target priority of the first container, determining the target priority of the first container and the target priority of the second container as a set of inversion pairs; and making a comparison on each container in the column of containers sequentially until the comparison ends to obtain the at least one second inversion pair at the end of the comparison.

When the state data of the state analysis factor is determined according to the target priority respectively corresponding to the at least one to-be-stacked container, by means of identifying the target priority as a sequence, the target priority respectively corresponding to the at least one to-be-stacked container may be combined into a priority sequence in accordance with an acquisition order. According to the formed priority sequence, an inversion pair with opposite priority orders is extracted, the number of inversion pairs is obtained, a difference between the inversion pairs is calculated, and a pick-up simulation is performed in accordance with the priority sequence to obtain the number of times of flipping. For example, assuming that S1 to S11 to-be-stacked containers are acquired in sequence, the target priorities determined for these 11 to-be-stacked containers are “13124131225”, pick-ups are performed in these orders, and the actual order of bills of loading is “131” “2413” “1225”.

For ease of understanding, from an example where the at least one state analysis factor includes the inversion pair, the inversion pair difference and the flipping parameter, the number of inversion pairs, the inversion pair difference value, and the number of times of flipping may be determined.

When performing a result comparison processing, the current stacking state and the candidate stacking state may be compared in terms of the number of inversion pairs, then one with the smallest number of inversion pairs is determine as the new candidate stacking state; if they have an equal number of inversion pairs, then a comparison is made in terms of the inversion pair difference and one with a minimum inversion pair difference value is determined as the new candidate stacking state; if they have an equal inversion pair difference value, then a comparison is made in terms of the flipping parameter and one with a smallest number of times of flipping is determined as the new candidate stacking state. Otherwise both of them are new candidate stacking states.

In the embodiment of the present disclosure, the at least one inversion pair and the number of inversion pairs may be determined according to the target priority respectively corresponding to the at least one to-be-stacked container to obtain the number of inversion pairs corresponding to the inversion pair in the stacking state. For any inversion pair, the difference value between the two target priorities in the inversion pair may be calculated to obtain the inversion pair difference value of the inversion pair and the inversion pair difference value respectively corresponding to the at least one inversion pair. At the same time, the number of times of flipping corresponding to the stacking state at the flipping parameter can be obtained according to the simulative stacking position respectively corresponding to the at least one to-be-stacked container in the stacking state, and the number of times of flipping that needs to be performed when performing the simulative pick-up in accordance with the target priority respectively corresponding to the at least one to-be-stacked container. Through the acquisition of the inversion pair, the calculation of the inversion pair difference value and the derive of the number of times of flipping via a flipping simulation, the state data of the inversion pair, the state data corresponding to the inversion pair difference and the state data corresponding to the flipping parameter can be accurately obtained, so as to realize an accurate acquisition of state data of each state analysis factor.

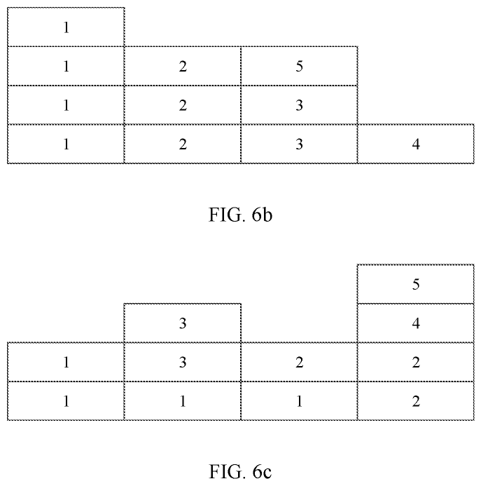

For ease of understanding, it is assumed that there are 11 to-be-stacked containers. The predicted target priorities for these 11 are: 13124131225, where in actual fetching, 131 are in a same bill of loading, 2413 are in a same bill of loading, and 1225 are in a same bill of loading. The stacking simulation is performed on these 11 to-be-stacked containers, with reference to the stacking examples shown in FIG. 3, in the stacking simulation manner of four containers A and three containers B, a sub-state simulation may be performed on “1111” in accordance with the stacking manner of four containers A and a stacking simulation may be performed on “222” in accordance with the stacking manner of three containers B. By using the same stacking simulation manner, the stacking simulation can be performed on “33” to generate two longitudinal sub-states and two lateral sub-states, there is only one sub-state for two to-be-stacked containers “4” and “5”. A sub-state will be selected from “1111”, “222”, “33”, “4” and “5” in sequence, and then five sub-states obtained by selection will be stacked to generate a stacking state. In a practical application, plural stacking states are included, for example, the stacking state shown in FIG. 6a and the stacking state shown in FIG. 6b.

It is assumed that the stacking state shown in FIG. 6a is a candidate stacking state generated from the previous comparison, and FIG. 6b is a determined current stacking state. With the priority sequence 13124131225 corresponding to the above predicted target priorities being used as an example, an order of a first 3 is before a second 1, and (3,1) is an inversion pair. In this sequence, this “3” also forms an inversion pair with 1 in “241”, and forms an inversion pair with “1” in “31225”. In addition, “31” in “31225” also forms an inversion pair. Therefore, the number of the inversion pairs (3,1) is 4, which may be represented as (3,1,4) in a three-dimensional array. There is also at least one first inversion pair such as the inversion pairs (4, 1, 2) and (3, 2, 2), and so on. The difference value of the inversion pair (3,1) is 2, and the difference value of the inversion pair (4,1) is 3.

With a same algorithm, the number of inversion pairs, the inversion pair difference value, and the number of times of flipping in FIG. 6a and FIG. 6b may be determined respectively. Where a second inversion pair (5,4) of the stacking state is shown in FIG. 6a. The second inversion pair (5,4) in FIG. 6a does not have an intersection with at least one first inversion pair in the original priority sequence, therefore, the target inversion pair in FIG. 6a is (5,4), and the number of inversion pairs is 1. In FIG. 6a, the number of inversion pairs is 1 and the inversion pair difference value is 1, assuming that a pick-up order is “131”, “2413”, and “1225”, at this time, the number of times of flipping is 2.

A second inversion pair (5,3) is presented in the stacking state shown in FIG. 6b. The second inversion pair (5,3) in FIG. 6b does not have an intersection with at least one first inversion pair in the original priority sequence, therefore, the target inversion pair in FIG. 6b is (5,3), and the number of inversion pairs is 2, assuming that the pick-up order is “131”, “2413” and “1225”, at this time, the number of times of flipping is 3.

Upon a comparison of the number of inversion pairs in FIG. 6a and FIG. 6b, the number in FIG. 6a is smaller than that in FIG. 6b. At this time, the stacking state of FIG. 6a can be determined as a new candidate stacking state. The stacking state of FIG. 6b is discarded. In a practical application, a plurality of stacking states may be included, and after comparing the plurality of stacking states respectively, a final target stacking state obtained may be as shown in FIG. 6c. By stacking the above 11 containers according to FIG. 6c, a pick-up of the containers “131”, “2413” and “1225” may be completed by only one time of flipping.

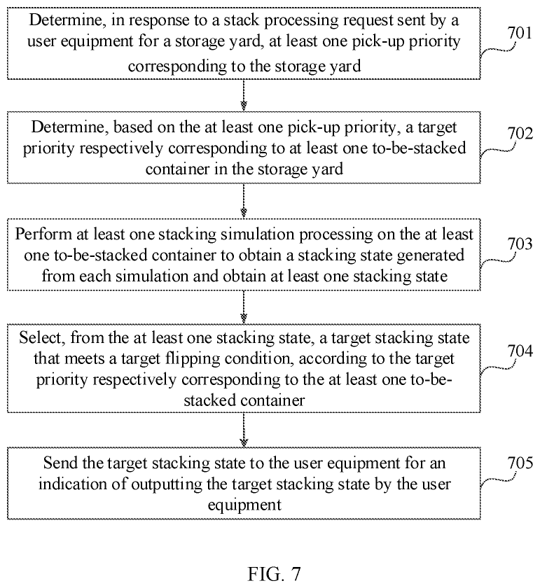

FIG. 7 shows a flowchart of a method for container stacking processing according to a fifth embodiment of the present disclosure. The method may include the following steps.

701, determine, in response to a stack processing request sent by a user equipment for a storage yard, at least one pick-up priority corresponding to the storage yard.

The pick-up priority is a planned pick-up order set for containers in the storage yard.

Some steps in the embodiments of the present disclosure are the same as those in the foregoing embodiments, and are not repeated here for the sake of brevity of description.

702, determine, based on the at least one pick-up priority, a target priority respectively corresponding to at least one to-be-stacked container in the storage yard.

703, perform at least one stacking simulation processing on the at least one to-be-stacked container to obtain a stacking state generated from each simulation and obtain at least one stacking state; where the stacking state includes a simulative stacking position respectively corresponding to the at least one to-be-stacked container after the stacking simulation processing.

704, select, from the at least one stacking state, a target stacking state that meets a target flipping condition, according to the target priority respectively corresponding to the at least one to-be-stacked container.

705, send the target stacking state to the user equipment for an indication of outputting the target stacking state by the user equipment.

The sending the target stacking state to the user equipment may include: sending a schematic stacking diagram corresponding to the target stacking state to the user equipment. The schematic stacking diagram may be indicative of stacking, by a user, the at least one to-be-stacked container in accordance with the schematic stacking diagram.

In the embodiment of the present disclosure, the stacking processing request sent by the user equipment for the storage yard may be received, and in response to the stacking processing request, a stacking simulation is performed on the at least one to-be-stacked container in the storage yard to obtain a target stacking state with a best stacking effect. The target stacking state may be output by the user equipment by sending the target stacking state to the user equipment. By checking the target stacking state, the user may stack the at least one to-be-stacked container in accordance with the target stacking state, so that the stacking state of the at least one to-be-stacked container meets the target flipping condition, ensuring a higher fetching efficiency in the stacking state.

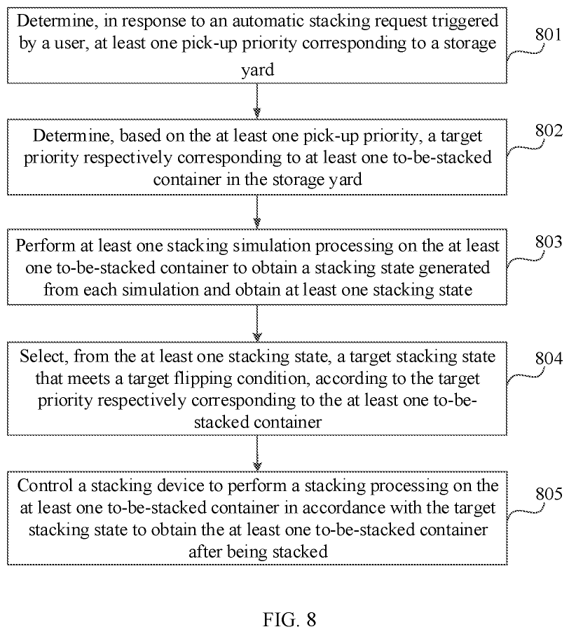

FIG. 8 shows a flowchart of a method for container stacking processing according to a sixth embodiment of the present disclosure. The method may include the following steps.

801, determine, in response to an automatic stacking request triggered by a user, at least one pick-up priority corresponding to a storage yard.

The pick-up priority is a planned pick-up order set for containers in the storage yard.

802, determine, based on the at least one pick-up priority, a target priority respectively corresponding to at least one to-be-stacked container in the storage yard.

803, perform at least one stacking simulation processing on the at least one to-be-stacked container to obtain a stacking state generated from each simulation and obtain at least one stacking state; where the stacking state includes a simulative stacking position respectively corresponding to the at least one to-be-stacked container after the stacking simulation processing.

804, select, from the at least one stacking state, a target stacking state that meets a target flipping condition, according to the target priority respectively corresponding to the at least one to-be-stacked container.

805, control a stacking device to perform a stacking processing on the at least one to-be-stacked container in accordance with the target stacking state to obtain the at least one to-be-stacked container after being stacked.

In an embodiment, controlling the stacking device to perform the stacking processing on the at least one to-be-stacked container in accordance with the target stacking state to obtain the at least one to-be-stacked container after being stacked may include: determining a stacking order respectively corresponding to the at least one to-be-stacked container according to the simulative stacking position respectively corresponding to the at least one to-be-stacked container in the target stacking state, generating stacking instructions in sequence for to-be-stacked containers according to stacking orders corresponding to the to-be-stacked containers and simulative stacking positions to obtain the stacking instructions corresponding to the at least one to-be-stacked container. The stacking instructions of the at least one to-be-stacked container are sent to the stacking device in sequence to control the stacking device to place, in response to a received stacking instruction, the stacking container corresponding to the stacking instruction into the simulative stacking position, to obtain the at least one to-be-stacked container after being stacked.

In the embodiment of the present disclosure, the automatic stacking request triggered by the user may be received, and in response to the automatic stacking request, the stacking simulation is performed on the at least one to-be-stacked container in the storage yard to obtain a target stacking state with the best stacking effect. The stacking of the at least one to-be-stacked container may be completed automatically, by controlling the stacking device, a stacking processing may be performed on the at least one to-be-stacked container in accordance with the target stacking state to obtain the at least one to-be-stacked container after being stacked. An automatic stacking simulation may be performed on the at least one to-be-stacked container through the target stacking state to improve the stacking efficiency. At the same time, in accordance with the target stacking efficiency, the stacking effect may be the best, an efficient and accurate stacking of the at least one to-be-stacked container in the storage yard may be realized.

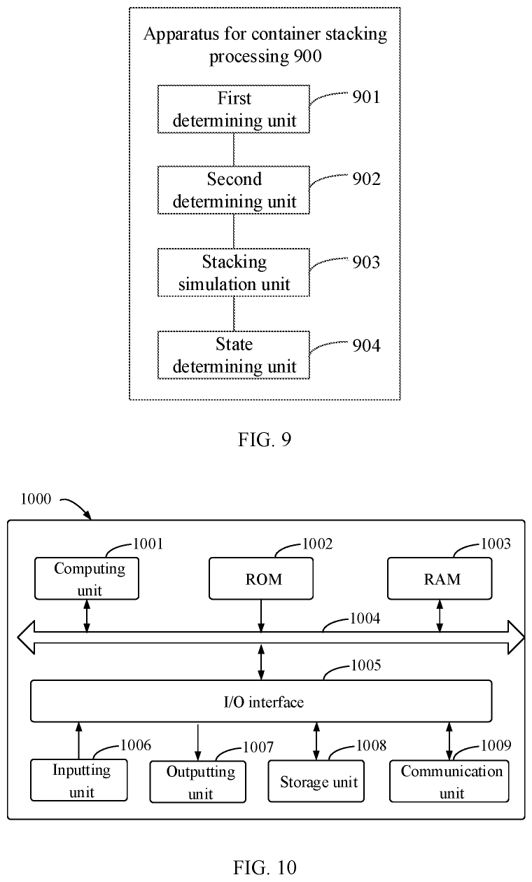

FIG. 9 shows a schematic structural diagram of an apparatus for container stacking processing according to a seventh embodiment of the present disclosure. The apparatus for container stacking processing 900 may include:

a first determining unit 901, configured to determine at least one pick-up priority corresponding to a storage yard; where the pick-up priority is a planned pick-up order set for containers in the storage yard;

a second determining unit 902, configured to determine, based on the at least one pick-up priority, a target priority respectively corresponding to at least one to-be-stacked container in the storage yard;

a stacking simulation unit 903, configured to perform at least one stacking simulation processing on the at least one to-be-stacked container to obtain a stacking state generated from each simulation and obtain at least one stacking state; where the stacking state includes a simulative stacking position respectively corresponding to the at least one to-be-stacked container after the stacking simulation processing;

a state determining unit 904, configured to select, from the at least one stacking state, a target stacking state that meets a target flipping condition, according to the target priority respectively corresponding to the at least one to-be-stacked container.

In the embodiment of the present disclosure, at least one pick-up priority corresponding to a storage yard may be determined, where the pick-up priority may be a planned pick-up order set for containers in the storage yard. The planned pick-up order may be an actual order for container fetching. A target priority respectively corresponding to at least one to-be-stacked container in the storage yard may be determined based on at least one pick-up priority. The determination of the target priority of the to-be-stacked container may render an accurate confirmation on a pick-up order of the to-be-stacked container. At least one stacking simulation processing is performed on the at least one to-be-stacked container to obtain a stacking state generated from each simulation and obtain at least one stacking state. The stacking state may include a simulative stacking position respectively corresponding to the at least one to-be-stacked container after the stacking simulation processing. A target stacking state that meets a target flipping condition in the at least one stacking state may be confirmed through the target priority respectively corresponding to the at least one to-be-stacked container, that is, an actual corresponding pick-up order of each stacking container, thereby achieving acquisition of the target stacking state. By acquiring the target stacking state, the simulative stacking position of the at least one to-be-stacked container may be determined, thereby reducing the number of times of flipping in a pick-up process and improving the stacking efficiency.

As an example, the first determining unit includes:

an information acquiring module, configured to acquire plural pieces of historical pick-up information of the storage yard; where the historical pick-up information includes a historical pick-up order of a container that has been picked up;

a level extracting module, configured to determine, according to historical pick-up orders respectively corresponding to the plural pieces of historical pick-up information, the at least one pick-up priority.

In some embodiments, the level extracting module includes:

an information clustering sub-module, configured to perform a clustering processing on the plural pieces of historical pick-up information to obtain at least one information category; where the information category includes at least one piece of historical pick-up information that meets a pick-up similarity condition;

a level determining sub-module, configured to determine, according to a historical pick-up order respectively corresponding to the at least one piece of historical pick-up information in the information category, a pick-up priority corresponding to the information category to obtain the pick-up priority respectively corresponding to the at least one information category.

As a possible implementation, the second determining unit includes:

a first acquiring module, configured to acquire the at least one to-be-stacked container corresponding to the storage yard;

a target determining module, configured to determine, from the at least one pick-up priority, the target priority of the to-be-stacked container to obtain the target priority respectively corresponding to the at least one to-be-stacked container.

In a possible design, the target determining module includes:

a feature extracting sub-module, configured to extract, according to pick-up information of the to-be-stacked container, a pick-up feature of the to-be-stacked container;

a probability determining sub-module, configured to determine a pick-up probability of the pick-up feature at the pick-up priority to obtain the pick-up probability respectively corresponding to the pick-up feature at the at least one pick-up priority;

a target determining sub-module, configured to determine, from the pick-up probability respectively corresponding to the at least one pick-up priority, a pick-up priority corresponding to a maximum pick-up probability as the target priority.

In some embodiments, the probability determining sub-module is specifically configured to:

determine a priority probability respectively corresponding to the at least one pick-up priority;

determine a feature probability corresponding to the pick-up feature;

determine a priori probability corresponding to the pick-up priority at the pick-up feature;

input the priority probability, the feature probability and the priori probability into a Naive Bayes formula, calculate to obtain a corresponding posterior probability to determine the posterior probability as the pick-up probability.

In at least one embodiment, the probability determining sub-module is specifically configured to:

extract a historical pick-up feature respectively corresponding to the historical pick-up information to obtain a plurality of historical pick-up features;

determine, from the plurality of historical pick-up features, a feature number of historical pick-up features that are the same as the pick-up feature;

calculate a ratio of the feature number to a total number of the plural pieces of historical pick-up information to obtain the feature probability corresponding to the pick-up feature.

As an embodiment, the feature extracting sub-module is specifically configured to:

acquire at least one target factor that affects priority confirmation;

determine, according to the pick-up information of the to-be-stacked container, feature data respectively corresponding to the to-be-stacked container at the at least one target factor;

determine the pick-up feature obtained from a feature splicing on the feature data respectively corresponding to the at least one target factor.

As another embodiment, the state determining unit includes:

a stacking evaluation module, configured to perform, according to the target priority respectively corresponding to the at least one to-be-stacked container, a stacking evaluation processing on the stacking state to obtain a state analysis result respectively corresponding to the at least one stacking state;

a result comparing module, configured to determine, according to the state analysis result respectively corresponding to the at least one stacking state, a stacking state whose state analysis result meets the target flipping condition as the target stacking state.

In some embodiments, the result comparing module includes:

a state selecting sub-module, configured to traverse the at least one stacking state to determine a current stacking state and a candidate stacking state that is determined from a previous result comparison processing;

a result comparing sub-module, configured to perform a result comparison processing between a state analysis result of the current stacking state and a state analysis result of the candidate stacking state to determine a new candidate stacking state whose state analysis result meets the target flipping condition, return to the step of traversing the at least one stacking state to determine the current stacking state and the previously determined candidate stacking state, and proceed with the execution until the traversing of the at least one stacking state ends;

a target determining sub-module, configured to obtain a new candidate stacking state obtained from a last traversal as the target stacking state.

As a possible implementation, the stacking evaluation module includes:

a factor determining sub-module, configured to determine at least one state analysis factor;

an order determining sub-module, configured to determine the simulative stacking position respectively corresponding to the at least one to-be-stacked container in the stacking state;

a data extracting sub-module, configured to extract, according to the simulative stacking position and the target priority respectively corresponding to the at least one to-be-stacked container, state data corresponding to the state analysis factor to obtain the state data respectively corresponding to the at least one state analysis factor;

a result determining sub-module, configured to determine the state data respectively corresponding to the at least one state analysis factor as the state analysis result of the stacking state to obtain the state analysis result respectively corresponding to the at least one stacking state.

In some embodiments, the result comparing sub-module is specifically configured to:

determine first state data respectively corresponding to the at least one state analysis factor in the state analysis result of the current stacking state and second state data respectively corresponding to the at least one state analysis factor in the state analysis result of the candidate stacking state;

determine, starting from a first state analysis factor, a current state analysis factor in accordance with an analysis order respectively corresponding to the at least one state analysis factor;

for the current state analysis factor, if it is determined that the first state data of the current state analysis factor in the current stacking state is smaller than the second state data corresponding to the candidate stacking state, then determine the current stacking state as the new candidate stacking state;

if it is determined that the first state data of the current state analysis factor in the current stacking state is greater than the second state data corresponding to the candidate stacking state, then determine the candidate stacking state as the new candidate stacking state;

if it is determined that the first state data of the current state analysis factor in the current stacking state is equal to the second state data corresponding to the candidate stacking state, return to the step of determining, starting from the first state analysis factor, the current state analysis factor in accordance with the analysis order respectively corresponding to the at least one state analysis factor, and proceed with the execution until comparison of a last state analysis factor ends;

if it is determined that the first state data of the last state analysis factor in the current stacking state is equal to the second state data corresponding to the candidate stacking state, then determine both the current stacking state and the candidate stacking state as the new candidate stacking state.

As an embodiment, the at least one state analysis factor includes an inversion pair, an inversion pair difference and a flipping parameter; the apparatus further includes:

an order determining unit, configured to determine, in accordance with an order from high to low, the analysis order respectively corresponding to the inversion pair, the inversion pair difference, and the flipping parameter.

As another embodiment, the data extracting sub-module is specifically configured to:

determine, according to the target priority respectively corresponding to the at least one to-be-stacked container, a target inversion pair of the stacking state;

determine a number of inversion pairs corresponding to the stacking state in the target inversion pair;

calculate a difference value between two target priorities in the target inversion pair to obtain an inversion pair difference value of the target inversion pair;

obtain the number of times of flipping corresponding to the stacking state at the flipping parameter, according to the simulative stacking position respectively corresponding to the at least one to-be-stacked container in the stacking state and the number of times of flipping needs to be performed when performing a simulation pick-up in accordance with the target priority respectively corresponding to the at least one to-be-stacked container;

determine the number of inversion pairs as the state data of the inversion pair, the inversion pair difference value as the state data of the inversion pair difference, and the number of times of flipping as the state data of the flipping parameter.

In some embodiments, the first determining unit includes:

a first responding module, configured to determine, in response to a stack processing request sent by a user equipment for the storage yard, the at least one pick-up priority corresponding to the storage yard.

The apparatus further includes:
a target sending unit, configured to send the target stacking state to the user equipment for an indication of outputting the target stacking state by the user equipment.

In a possible design, the first determining unit includes:

a second responding module, configured to determine, in response to an automatic stacking request triggered by a user, the at least one pick-up priority corresponding to the storage yard;

a target controlling module, configured to control a stacking device to perform a stacking processing on the at least one to-be-stacked container in accordance with the target stacking state to obtain the at least one to-be-stacked container after being stacked.

As an embodiment, the stacking simulation unit may include:

a priority classifying module, configured to classify the at least one to-be-stacked container in accordance with their respective target priorities to obtain target containers respectively corresponding to at least one target priority;

a sub-state simulation module, configured to perform a sub-stacking simulation on target containers belonging to a same target priority to obtain at least one sub-state of the target priority, and determine at least one sub-state respectively corresponding to the at least one target priority;

a sub-state selecting module, configured to for any stacking simulation processing, determine a target sub-state from at least one sub-state of any target priority, select a corresponding target sub-state for the at least one target priority sequentially;

a sub-state splicing module, configured to perform a state splicing on the target sub-state of the at least one target priority to obtain the stacking state generated from the stacking simulation processing.

The apparatus for container stacking processing in the embodiment of the present disclosure may execute the method for container stacking processing in the above-mentioned embodiments. For specific content with regard to execution of each unit, module, and sub-module, reference may be made to the description in the above-mentioned embodiments, which is not repeated here.

It should be noted that the user in this embodiment does not refer to a certain specific user, and cannot reflect personal information of the certain specific user. In the technical solutions of the present disclosure, the collection, storage, usage, processing, transmission, provision, publication and other applications of a user's personal information are in compliance with the provisions of relevant laws and regulations, and do not violate public order and good customs.

According to embodiments of the present disclosure, the present disclosure also provides an electronic device, a readable storage medium, and a computer program product.

According to an embodiment of the present disclosure, the present disclosure also provides a computer program product, where the computer program product includes a computer program stored in a readable storage medium, at least one processor of an electronic device may read the computer program from the readable storage medium, and the at least one processor executes the computer program to enable the electronic device to execute the solution provided in any one of the aforementioned embodiments.

FIG. 10 shows a schematic block diagram of an exemplary electronic device 1000 which can be used to implement embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital assistant, cellular phones, smart phones, wearable devices, and other similar computing apparatuses. The components and their connections and relationships, as well as their functions shown herein are merely exemplary, and are not intended to limit the implementations of the present disclosure described and/or claimed herein.

As shown in FIG. 10, the electronic device 1000 includes a computing unit 1001, which may perform various appropriate actions and processes according to a computer program stored in a read-only memory (ROM) 1002 or a computer program loaded from a storage unit 1008 into a random access memory (RAM) 1003. In the RAM 1003, various programs and data required for operations of the electronic device 1000 may also be stored. The computing unit 1001, the ROM 1002 and the RAM 1003 are connected to each other through a bus 1004. An input/output (I/O) interface 1005 is also connected to the bus 1004.

Multiple components in the electronic device 1000 are connected to the I/O interface 1005, and include: an inputting unit 1006, such as a keyboard, a mouse, and the like; an outputting unit 1007, such as various types of displays, speakers, and the like; a storage unit 1008, such as a magnetic disk, an optical disk, and the like; and a communication unit 1009, such as a network card, a modem, a wireless communication transceiver, and the like. The communication unit 1009 allows the electronic device 1000 to exchange information/data with other devices over a computer network such as Internet and/or various telecommunication networks.

The computing unit 1001 may be various general-purpose and/or special-purpose processing components with processing and computing capabilities. Some examples of the computing unit 1001 include, but are not limited to, a central processing unit (CPU), a graphics processing unit (GPU), various dedicated artificial intelligence (AI) computing chips, various computing units that run machine learning model algorithms, a digital signal processor (DSP), and also any appropriate processors, controllers, microcontrollers, and the like. The computing unit 1001 executes each method and process described above, such as a method for container stacking processing. For example, in some embodiments, the method for container stacking processing can be implemented as a computer program, which is tangibly contained in a machine-readable medium, such as the storage unit 1008. In some embodiments, part or entirety of the computer program may be loaded and/or installed on the electronic device 1000 via the ROM 1002 and/or the communication unit 1009. When the computer program is loaded into the RAM 1003 and executed by the computing unit 1001, one or more steps of the method for container stacking processing as described above may be executed. Alternatively, in other embodiments, the computing unit 1001 may be configured to execute the method for container stacking processing, in any other suitable manner (for example, by means of firmware).

Various implementations of the system and technology described above herein may be implemented in digital electronic circuit systems, integrated circuit systems, field programmable gate arrays (FPGA), application specific integrated circuits (ASIC), application specific standard parts (ASSP), system-on-chips (SOC), complex programmable logic devices (CPLD), computer hardware, firmware, software, and/or a combination thereof. These various implementations may include: being implemented in one or more computer programs, where the one or more computer programs may be executed and/or interpreted on a programmable system including at least one programmable processor. The programmable processor may be a special-purpose or general-purpose programmable processor, can receive data and instructions from a storage system, at least one input apparatus and at least one output apparatus, and transmit the data and instructions to the storage system, the at least one input apparatus and the at least one output apparatus.

Program codes for implementing a method of the present disclosure can be written in one programming language or any combination of multiple programming languages. These program codes can be provided to a processor or a controller of a general-purpose computer, a special-purpose computer, or other programmable data processing apparatus, so that functions/operations specified in flowcharts and/or block diagrams are implemented when the program codes are executed by the processor or the controller. The program codes may be executed entirely on a machine, partly on a machine, partly executed on a machine and partly executed on a remote machine as an independent software package, or entirely executed on a remote machine or a server.

In the context of the present disclosure, the machine-readable medium may be a tangible medium, which may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductive system, apparatus, or device, or any suitable combination of the foregoing. More specific examples of the machine-readable storage medium would include an electrically connected portable computer disk based on one or more wires, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any suitable combination of the foregoing.

In order to provide interaction with users, the system and technology described herein can be implemented on a computer, where the computer has: a display apparatus for displaying information to users (for example, a CRT (cathode ray tube) or LCD (liquid crystal display) monitor); and a keyboard and a pointing apparatus (for example, a mouse or a trackball) through which the user can provide inputs to the computer. Other kinds of apparatuses may also be used to provide interaction with the user, for example, the feedback provided to the user may be any form of sensory feedback (for example, visual feedback, auditory feedback, or tactile feedback); and may receive inputs from the user in any form (including acoustic inputs, voice inputs, or tactile inputs).

The system and technology described herein can be implemented in a computing system that includes background components (for example, as a data server), or a computing system that includes middleware components (for example, an application server), or a computing system that includes front-end components (for example, a user computer with a graphical user interface or a web browser through which the user can interact with implementations of the system and technology described herein), or a computing system that includes any combination of such background components, middleware components or front-end components. The components of the system can be connected to each other through digital data communication in any form or medium (for example, a communication network). Examples of the communication network include: a local area network (LAN), a wide area network (WAN) and the Internet.

The computing system may include a client and a server. The client and server are generally remote from each other and usually interact through a communication network. A relationship between the client and the server is generated through computer programs running on corresponding computers and having a client-server relationship with each other. The server may be a cloud server, also known as a cloud computing server or a cloud host, which is a host product in a cloud computing service system to overcome defects of huge management difficulty and weak business scalability existing in a traditional physical host and a VPS service (“Virtual Private Server”, or “VPS” for short). The server may also be a server of a distributed system, or a server combined with a blockchain.

It should be understood that various forms of processes shown above may be used to reorder, add or delete steps. For example, the steps described in the present disclosure may be executed in parallel, sequentially or in a different order, as long as a desired result of the technical solution disclosed in the present disclosure can be achieved, and there is no limitation herein.

The aforementioned specific implementations do not constitute a limitation to the protection scope of the present disclosure. It should be understood by those skilled in the art that various modifications, combinations, sub-combinations and substitutions may be performed according to design requirements and other factors. Any modification, equivalent replacement, improvement and the like made within the spirit and principle of the present disclosure shall be included in the protection scope of the present disclosure.

What is claimed is:

1. A method for container stacking processing, comprising:
determining at least one pick-up priority corresponding to a storage yard; wherein the pick-up priority is a planned pick-up order set for containers in the storage yard;
determining, based on the at least one pick-up priority, a target priority respectively corresponding to at least one to-be-stacked container in the storage yard;
performing at least one stacking simulation processing on the at least one to-be-stacked container to obtain a stacking state generated from each simulation and obtain at least one stacking state; wherein the stacking state comprises a simulative stacking position respectively corresponding to the at least one to-be-stacked container after the stacking simulation processing;
selecting, from the at least one stacking state, a target stacking state that meets a target flipping condition, according to the target priority respectively corresponding to the at least one to-be-stacked container.

2. The method according to claim 1, wherein the determining the at least one pick-up priority corresponding to the storage yard comprises:
acquiring plural pieces of historical pick-up information of the storage yard; wherein the historical pick-up information comprises a historical pick-up order of a container that has been picked up;
determining, according to historical pick-up orders respectively corresponding to the plural pieces of historical pick-up information, the at least one pick-up priority.

3. The method according to claim 2, wherein the determining, according to the historical pick-up orders respectively corresponding to the plural pieces of historical pick-up information, the at least one pick-up priority comprises:
performing a clustering processing on the plural pieces of historical pick-up information to obtain at least one information category; wherein the information category comprises at least one piece of historical pick-up information that meets a pick-up similarity condition;
determining, according to a historical pick-up order respectively corresponding to the at least one piece of historical pick-up information in the information category, a pick-up priority corresponding to the information category to obtain the pick-up priority respectively corresponding to the at least one information category.

4. The method according to claim 1, wherein the determining, based on the at least one pick-up priority, the target priority respectively corresponding to the at least one to-be-stacked container in the storage yard comprises:
acquiring the at least one to-be-stacked container corresponding to the storage yard;
determining, from the at least one pick-up priority, the target priority of the to-be-stacked container to obtain the target priority respectively corresponding to the at least one to-be-stacked container.

5. The method according to claim 4, wherein the determining, from the at least one pick-up priority, the target priority of the to-be-stacked container comprises:
extracting, according to pick-up information of the to-be-stacked container, a pick-up feature of the to-be-stacked container;
determining a pick-up probability of the pick-up feature at the pick-up priority to obtain the pick-up probability respectively corresponding to the pick-up feature at the at least one pick-up priority;
determining, from the pick-up probability respectively corresponding to the at least one pick-up priority, a pick-up priority corresponding to a maximum pick-up probability as the target priority.

6. The method according to claim 5, wherein the determining the pick-up probability of the pick-up feature at the pick-up priority comprises:
determining a priority probability respectively corresponding to the at least one pick-up priority;
determining a feature probability corresponding to the pick-up feature;
determining a priori probability corresponding to the pick-up priority at the pick-up feature;
inputting the priority probability, the feature probability and the priori probability into a Naive Bayes formula, calculating to obtain a corresponding posterior probability to determine the posterior probability as the pick-up probability.

7. The method according to claim 6, wherein the determining the feature probability corresponding to the pick-up feature comprises:
determining plural pieces of historical pick-up information;
extracting a historical pick-up feature respectively corresponding to the historical pick-up information to obtain a plurality of historical pick-up features;
determining, from the plurality of historical pick-up features, a feature number of historical pick-up features that are the same as the pick-up feature;
calculating a ratio of the feature number to a total number of the plural pieces of historical pick-up information to obtain the feature probability corresponding to the pick-up feature.

8. The method according to claim 5, wherein the extracting, according to the pick-up information of the to-be-stacked container, the pick-up feature of the to-be-stacked container comprises:
acquiring at least one target factor that affects priority confirmation;
determining, according to the pick-up information of the to-be-stacked container, feature data respectively corresponding to the to-be-stacked container at the at least one target factor;
determining the pick-up feature obtained from a feature splicing on the feature data respectively corresponding to the at least one target factor.

9. The method according to claim 1, wherein the selecting, from the at least one stacking state, the target stacking state that meets the target flipping condition, according to the target priority respectively corresponding to the at least one to-be-stacked container comprises:
performing, according to the target priority respectively corresponding to the at least one to-be-stacked container, a stacking evaluation processing on the stacking state to obtain a state analysis result respectively corresponding to the at least one stacking state;
determining, according to the state analysis result respectively corresponding to the at least one stacking state, a stacking state whose state analysis result meets the target flipping condition as the target stacking state.

10. The method according to claim 9, wherein the determining, according to the state analysis result respectively corresponding to the at least one stacking state, the stacking state whose state analysis result meets the target flipping condition as the target stacking state comprises:
traversing the at least one stacking state to determine a current stacking state and a candidate stacking state that is determined from a previous result comparison processing;
performing a result comparison processing between a state analysis result of the current stacking state and a state analysis result of the candidate stacking state to determine a new candidate stacking state whose state analysis result meets the target flipping condition, returning to the step of traversing the at least one stacking state to determine the current stacking state and the previously determined candidate stacking state, and proceeding with the execution until the traversing of the at least one stacking state ends;
obtaining a new candidate stacking state obtained from a last traversal, as the target stacking state.

11. The method according to claim 10, wherein the performing, according to the target priority respectively corresponding to the at least one to-be-stacked container, the stacking evaluation processing on the stacking state to obtain the state analysis result respectively corresponding to the at least one stacking state comprises:
determining at least one state analysis factor;
determining the simulative stacking position respectively corresponding to the at least one to-be-stacked container in the stacking state;
extracting, according to the simulative stacking position and the target priority respectively corresponding to the at least one to-be-stacked container, state data corresponding to the state analysis factor to obtain the state data respectively corresponding to the at least one state analysis factor;
determining the state data respectively corresponding to the at least one state analysis factor as the state analysis result of the stacking state to obtain the state analysis result respectively corresponding to the at least one stacking state.

12. The method according to claim 11, wherein the performing the result comparison processing between the state analysis result of the current stacking state and the state analysis result of the candidate stacking state to determine the new candidate stacking state whose state analysis result meets the target flipping condition comprises:
determining first state data respectively corresponding to the at least one state analysis factor in the state analysis result of the current stacking state and second state data respectively corresponding to the at least one state analysis factor in the state analysis result of the candidate stacking state;
determining, starting from a first state analysis factor, a current state analysis factor in accordance with an analysis order respectively corresponding to the at least one state analysis factor;
for the current state analysis factor, if it is determined that the first state data of the current state analysis factor in the current stacking state is smaller than the second state data corresponding to the candidate stacking state, then determining the current stacking state as the new candidate stacking state;
if it is determined that the first state data of the current state analysis factor in the current stacking state is greater than the second state data corresponding to the candidate stacking state, then determining the candidate stacking state as the new candidate stacking state;
if it is determined that the first state data of the current state analysis factor in the current stacking state is equal to the second state data corresponding to the candidate stacking state, returning to the step of determining, starting from the first state analysis factor, the current state analysis factor in accordance with the analysis order respectively corresponding to the at least one state analysis factor, and proceeding with the execution until comparison of a last state analysis factor ends;
if it is determined that the first state data of the last state analysis factor in the current stacking state is equal to the second state data corresponding to the candidate stacking state, then determining both the current stacking state and the candidate stacking state as the new candidate stacking state.

13. The method according to claim 11, wherein the at least one state analysis factor comprises an inversion pair, an inversion pair difference and a flipping parameter; the method further comprises:
determining, in accordance with an order from high to low, the analysis order respectively corresponding to the inversion pair, the inversion pair difference, and the flipping parameter.

14. The method according to claim 13, wherein the extracting, according to the simulative stacking position and the target priority respectively corresponding to the at least one to-be-stacked container, the state data corresponding to the state analysis factor to obtain the state data respectively corresponding to the at least one state analysis factor comprises:
determining, according to the target priority respectively corresponding to the at least one to-be-stacked container, a target inversion pair of the stacking state;
determining a number of inversion pairs corresponding to the stacking state in the target inversion pair;
calculating a difference value between two target priorities in the target inversion pair to obtain an inversion pair difference value of the target inversion pair;
obtaining a number of times of flipping corresponding to the stacking state at the flipping parameter, according to the simulative stacking position respectively corresponding to the at least one to-be-stacked container in the stacking state and a number of times of flipping needs to be performed when performing a simulative pick-up in accordance with the target priority respectively corresponding to the at least one to-be-stacked container;
determining the number of inversion pairs as the state data of the inversion pair, the inversion pair difference value as the state data of the inversion pair difference, and the number of times of flipping as the state data of the flipping parameter.

15. The method according to claim 1, wherein the determining the at least one pick-up priority corresponding to the storage yard comprises:
determining, in response to a stack processing request sent by a user equipment for the storage yard, the at least one pick-up priority corresponding to the storage yard;
after the selecting, from the at least one stacking state, the target stacking state that meets the target flipping condition, the method further comprises:
sending the target stacking state to the user equipment for an indication of outputting the target stacking state by the user equipment.

16. The method according to claim 1, wherein the determining the at least one pick-up priority corresponding to the storage yard comprises:
determining, in response to an automatic stacking request triggered by a user, the at least one pick-up priority corresponding to the storage yard;
after the selecting, from the at least one stacking state, the target stacking state that meets the target flipping condition, the method further comprises:
controlling a stacking device to perform a stacking processing on the at least one to-be-stacked container in accordance with the target stacking state to obtain the at least one to-be-stacked container after being stacked.

17. The method according to claim 1, wherein the performing the at least one stacking simulation processing on the at least one to-be-stacked container to obtain the stacking state generated from each simulation comprises:
classifying the at least one to-be-stacked container in accordance with their respective target priorities to obtain target containers respectively corresponding to at least one target priority;
performing a sub-stacking simulation on target containers belonging to a same target priority to obtain at least one sub-state of the target priority, and determining at least one sub-state respectively corresponding to the at least one target priority;
for any stacking simulation processing, determining a target sub-state from at least one sub-state of any target priority, selecting a corresponding target sub-state for the at least one target priority sequentially;
performing a state splicing on the target sub-state of the at least one target priority to obtain the stacking state generated from the stacking simulation processing.

18. An apparatus for container stacking processing, comprising:
at least one processor, and
a memory communicatively connected with the at least one processor; wherein,
the memory stores an instruction executable by the at least one processor, and the instruction is executed by the at least one processor to enable the at least one processor to:
determine at least one pick-up priority corresponding to a storage yard; wherein the pick-up priority is a planned pick-up order set for containers in the storage yard;
determine, based on the at least one pick-up priority, a target priority respectively corresponding to at least one to-be-stacked container in the storage yard;
perform at least one stacking simulation processing on the at least one to-be-stacked container to obtain a stacking state generated from each simulation and obtain at least one stacking state; wherein the stacking state comprises a simulative stacking position respectively corresponding to the at least one to-be-stacked container after the stacking simulation processing;
select, from the at least one stacking state, a target stacking state that meets a target flipping condition, according to the target priority respectively corresponding to the at least one to-be-stacked container.

19. The apparatus according to claim 18, wherein the instruction is executed by the at least one processor to enable the at least one processor to:
acquire plural pieces of historical pick-up information of the storage yard; wherein the historical pick-up information comprises a historical pick-up order of a container that has been picked up;
determine, according to historical pick-up orders respectively corresponding to the plural pieces of historical pick-up information, the at least one pick-up priority.

20. A non-transitory computer readable storage medium, having a computer instruction stored thereon, wherein the computer instruction is used to enable a computer to execute the following steps:
determining at least one pick-up priority corresponding to a storage yard; wherein the pick-up priority is a planned pick-up order set for containers in the storage yard;
determining, based on the at least one pick-up priority, a target priority respectively corresponding to at least one to-be-stacked container in the storage yard;
performing at least one stacking simulation processing on the at least one to-be-stacked container to obtain a stacking state generated from each simulation and obtain at least one stacking state; wherein the stacking state comprises a simulative stacking position respectively corresponding to the at least one to-be-stacked container after the stacking simulation processing;
selecting, from the at least one stacking state, a target stacking state that meets a target flipping condition, according to the target priority respectively corresponding to the at least one to-be-stacked container.
